(19) United States
(12) Patent Application Publication
(10) Pub. No.: US 2022/0302735 A1
(43) Pub. Date: Sep. 22, 2022

(54) POWER SUPPLY SYSTEM

(71) Applicant: HONDA MOTOR CO., LTD., Tokyo (JP)

(72) Inventor: Hiroki SAKAMOTO, Tokyo (JP)

(21) Appl. No.: 17/678,031

(22) Filed: Feb. 23, 2022

(30) Foreign Application Priority Data
Mar. 19, 2021 (JP) 2021-046087

(51) Int. Cl. H02J 7/00; G05B 15/02; B60L 58/18; B60L 58/26; B60L 53/20

(52) U.S. Cl. CPC H02J 7/00719; H02J 7/0013; H02J 7/0063; G05B 15/02; B60L 58/18; B60L 58/26; B60L 53/20; B60L 2240/545

(57) ABSTRACT

A power supply system includes: power circuits that connect first and second batteries to a load circuit; a power controller that controls output power of the first and second batteries; and an allowable output upper limit acquirer that acquires a first allowable output upper limit P1_lim of the first battery and a second allowable output upper limit P2_lim of the second battery. The power controller is configured to switch, based on battery temperatures T1 and T2, a battery output control mode between a first priority output mode in which the output power of the first battery is increase to the first allowable output upper limit P1_lim in preference to that of the second battery and a second priority output mode in which the output power of the second battery is increased to the second allowable output upper limit P2_lim in preference to that of the first battery.

This application is based on and claims the benefit of priority from Japanese Patent Application No. 2021-046067, filed on 19 Mar. 2021, the content of which is incorporated herein by reference.

### BACKGROUND OF THE INVENTION

### Field of the Invention

The present invention relates to a power supply system. More specifically, the present invention relates to a power supply system including two electrical storage devices.

### Related Art

In recent years, electric vehicles, such as electric transport equipment equipped with a drive motor as a motive power generation source and hybrid vehicles equipped with a drive motor and an internal combustion engine as motive power generation sources, have been developed actively. Such an electric vehicle is also equipped with an electrical storage device (for example, a battery or a capacitor) for supplying electrical energy to the drive motor. Furthermore, vehicles equipped with a plurality of electrical storage devices with having different characteristics have recently been developed.

For example, Japanese Unexamined Patent Application, Publication No. 2017-70078 discloses a power supply system mountable on an electric vehicle and including a capacitance type battery and an output type battery are connected to a drive motor via a power circuit. This power supply system including two batteries having different characteristics allows the vehicle to travel only with power outputted from the capacitance type battery and to travel with power obtained by a combination of the power outputted from the capacitance type battery and power outputted by the output type battery, for example.
Patent Document 1: Japanese Unexamined Patent Application, Publication No. 2017-70078

### SUMMARY OF THE INVENTION

Meanwhile, supplying power from a battery to a drive motor via a power circuit causes various circuit losses. Among the circuit losses that occur in the overall power system, the loss due to internal resistance of the battery is the largest. However, according to the related art, such circuit losses that are caused in a power supply system due to supply of power from the batteries are not sufficiently considered.

An object of the present invention is to provide a power supply system capable of outputting power from two electrical storage devices while causing a small circuit loss.

(1) A power supply system (for example, a power supply system 1 described later) according to an embodiment of the present invention includes: a first electrical storage device (for example, a first battery B1 described later); a second electrical storage device (for example, a second battery B2 described later); a load circuit (for example, a load circuit 4 described later) including a rotary electrical machine (for example, a drive motor M described later); a power circuit (for example, a first power circuit 2 and a second power circuit 3 described later) that connects the first and second electrical storage devices to the load circuit; a power controller (for example, a management ECU 71, a motor ECU 72, and a converter ECU 73 described later) that controls output power of the first electrical storage device and output power of the second electrical storage device by operating the power circuit; a temperature acquirer (for example, a first battery ECU 74, a second battery ECU 75, a first battery sensor unit 81, and a second battery sensor unit 82 described later) that acquires a first temperature (for example, a first battery temperature T1 described later) as a temperature of the first electrical storage device and a second temperature (for example, a second battery temperature T2 described later) as a temperature of the second electrical storage device; and an allowable output upper limit acquirer (for example, a management. ECU 71, a first battery ECU 74, a second battery ECU 75, a first battery sensor unit 81, and a second battery sensor unit 82 described later) that acquires a first allowable output upper limit (for example, a first allowable output upper limit P1_lim described later) for the output power of the first electrical storage device and a second allowable output upper limit (for example, a second allowable output upper limit P2_lim described later) for the output power of the second electrical storage device. The power controller is configured to switch, based on the first temperature and the second temperature, a control mode between a first priority output mode in which the output power of the first electrical storage device is increased up to the first allowable output upper limit in preference to that of the second electrical storage device and a second priority output mode in which the output power of the second electrical storage device is increased up to the second allowable output upper limit in preference to that of the first electrical storage device.

(2) In this case, preferably, the power supply system further includes: a cooling circuit (for example, a cooling circuit 9, and a first cooler 91 and a second cooler 92 thereof described later) that cools the first electrical storage device and the second electrical storage device; and a cooling output controller (for example, a cooling circuit ECU 76 described later) that controls a first cooling output for the first electrical storage device by the cooling circuit and a second cooling output for the second electrical storage device by the cooling circuit. In a case where the first temperature is lower than a first temperature reference value (for example, a first temperature reference value T1_bs described later), the cooling output controller reduces the first cooling output as compared with a case where the first temperature is equal to or higher than the first temperature reference value. In a case where the second temperature is lower than a second temperature reference value (for example, a second temperature reference value T2_bs described later), the cooling output controller reduces the second cooling output as compared with a case where the second temperature is equal to or higher than the second temperature reference value.

(3) In this case, preferably, the power controller sets the control mode to the first priority output mode in case where the first temperature is equal to or higher than the first temperature reference value and the second temperature is lower than the second temperature reference value, and sets the control mode to the second priority output mode in a case where the first temperature is lower than the first temperature reference value and the second temperature is equal to or higher than the second temperature reference value.

(4) In this case, preferably, the power supply system further includes: a loss acquirer (for example, a management ECU 71 described later) that acquires a first loss (for example, a first loss Ploss1 described later) that is caused in the first electrical storage device and the power circuit when the control mode is set to the first priority output mode, and a second loss (for example, a second loss Ploss2 described later) that is caused in the second electrical storage device and the power circuit when the control mode is set to the second priority output mode. Preferably, in a case where the first temperature is equal to or higher than the first temperature reference value and the second temperature is equal to or higher than the second temperature reference value, the power controller sets the control mode to the second priority output mode when the first loss is larger than the second loss and sets the control mode to the first priority output mode when the second loss is larger than the first loss.

(5) In this case, preferably, the power supply system further includes: a first power circuit (for example, a first power circuit 2 described later) including a first electrical storage device; a second power circuit (for example, a second power circuit 3 described later) including a second electrical storage device; a voltage converter (for example, a voltage converter 5 described later) that converts a voltage between the first power circuit and the second power circuit; and a power converter (for example, a power converter 43 described later) that connects the first power circuit to the rotary electrical machine, and the power controller sets the control mode to the first priority output mode in a case where the first temperature is equal to or higher than the first temperature reference value and the second temperature is equal to or higher than the second temperature reference value.

(6) In this case, preferably, the second electrical storage device has a heat capacity smaller than that of the first electrical storage device, and the power controller sets the control mode to the second priority output mode in a case where the first temperature is lower than the first temperature reference value and the second temperature is lower than the second temperature reference value.

(1) Among the circuit losses that are caused in the power supply system in which the first and second electrical storage devices are connected to the load circuit via the power circuit, the loss that is caused in the first electrical storage device or the second electrical storage device is the largest. Further, the circuit losses that are caused in the first and second electrical storage devices change depending on the respective temperatures. To address this, the power controller of the present invention switches, based on the first and second temperatures, the power controller switches the control mode to the first priority output mode in which the output power of the first electrical storage device is increased up to the first allowable output upper limit in preference to that of the second electrical storage device and the second priority output mode in which the output power of the second electrical storage device is increased up to the second allowable output upper limit in preference to that of the first electrical storage device. Therefore, according to the present invention, the electrical storage device to be used preferentially can be switched such that the circuit losses in the entire power supply system are reduced. Further, reduction of the circuit losses makes it possible to continuously drive the rotary electrical machine for a long time.

(2) In the present invention, in the case where the first temperature is lower than the first temperature reference value, the cooling output controller reduces the first cooling output of the cooling circuit as compared with the case where the first temperature is equal to or higher than the first temperature reference value. In the case where the second temperature is lower than the second temperature reference value, the cooling output controller reduces the second cooling output of the cooling circuit as compared with the case where the second temperature is equal to or higher than the second temperature reference value. Due to this feature, each of the first and second temperatures can be rapidly increased, and the power consumption of the cooling circuit can be reduced, whereby the rotary electrical machine can be continuously driven for a longer time.

(3) When the first temperature is equal to or higher than the first temperature reference value and the second temperature is lower than the second temperature reference value, the power controller sets the control mode to the first priority output mode, and thereby preferentially causing the first electrical storage device having a relatively high temperature to discharge. Thus, the circuit loss can be reduced as compared with the case where the second electrical storage device having a relatively low temperature is preferentially caused to discharge. Further, when the first temperature is lower than the first temperature reference value and the second temperature is equal to or higher than the second temperature reference value, the power controller sets the control mode to the second priority output mode, thereby preferentially causing the second electrical storage device having a relatively high temperature to discharge.

Thus, the circuit loss can be reduced as compared with the case where the first electrical storage device having a relatively low temperature is preferentially caused to discharge.

(4) In the present invention, the loss acquirer acquires the first loss when the control mode is set to the first priority output mode and the second loss when the control mode is set to the second priority output mode. Further, in the case where the first temperature is equal to or higher than the first temperature reference value and the second temperature is equal to or higher than the second temperature reference value, the power controller sets the control mode to the second priority output mode leading to a lower loss when the first loss is larger than the second loss, and sets the control mode to the first priority output mode leading to a lower loss when the second loss is larger than the first loss. This feature makes it possible to further reduce the circuit losses in the power supply system.

(5) In the present invention, the first electrical storage device is connected to the rotary electrical machine via the power converter, and the second electrical storage device is connected to the rotary electrical machine via the power converter and the voltage converter. Therefore, assuming that the circuit loss in the first electrical storage device is equal to the circuit loss in the second electrical storage device, since more power passes through the voltage converter in the second priority output mode than in the first priority output mode, the loss is larger in the second priority output mode than in the first priority output mode. Therefore, when the first temperature is equal to or higher than the first temperature reference value and the second temperature is equal to or higher than the second temperature reference value, the power controller sets the control mode to the first priority output mode leading to a lower loss. This feature makes it possible to further reduce the circuit losses in the power supply system.

(6) In the present invention, when the first temperature is lower than the first temperature reference value and the second temperature is lower than the second temperature reference value, the power controller sets the control mode to the second priority output mode, thereby preferentially causing the second electrical storage device having a relatively small heat capacity to discharge. Due to this feature, the temperature of the second electrical storage device can be rapidly increased, and thus the circuit losses in the power supply system can be further reduced.

### BRIEF DESCRIPTION OF THE DRAWINGS

FIG. 1 is a diagram showing the configuration of a vehicle equipped with a power supply system according to a first embodiment of the present invention;

FIG. 2 is a diagram showing an example of the circuit configuration of a voltage converter;

FIG. 3 is a diagram showing an example of a circuit configuration of a cooling circuit;

FIG. 4 is a flowchart showing a specific procedure of power management processing;

FIG. 5A is a first flowchart showing a specific procedure of target passing power calculation processing;

FIG. 5B is a second flowchart showing a specific procedure of target passing power calculation processing;

FIG. 6 shows an example of a control mode determination table; and

FIG. 7 shows an example of a control mode determination table of a power supply system according to a second embodiment of the present invention.

### DETAILED DESCRIPTION OF THE INVENTION

### First Embodiment

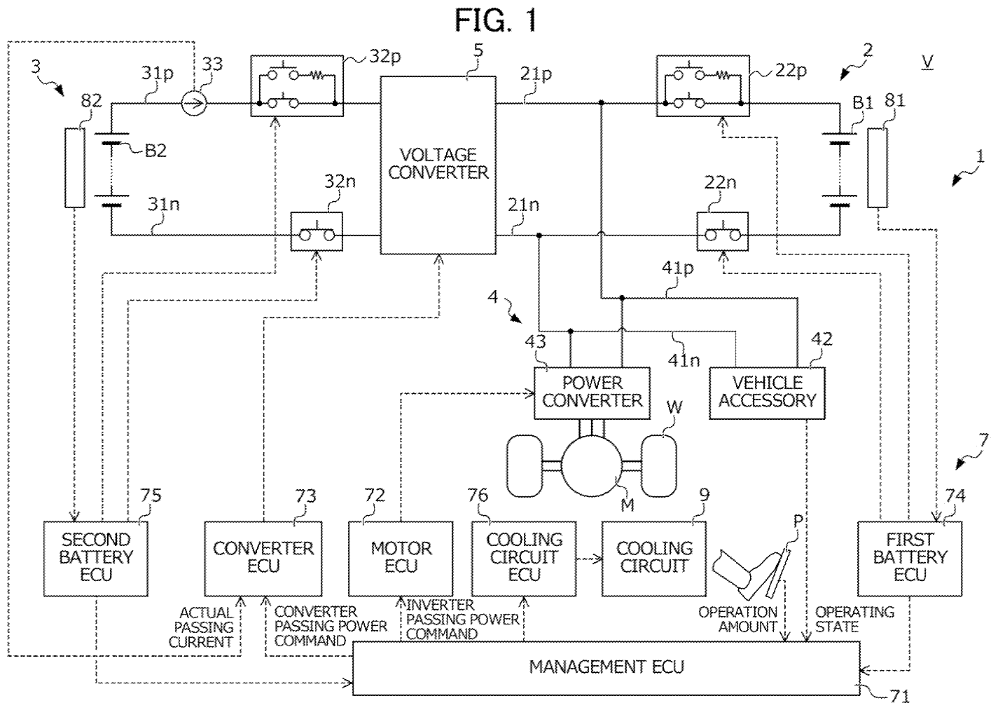

A first embodiment of the present invention will be described with reference to the drawings. FIG. 1 is a diagram showing the configuration of a four-wheeled electric vehicle V (hereinafter simply referred as “vehicle”) mounted with a power supply system 1 according to the present embodiment. In the present embodiment, a case will be described where the power supply system 1 is mounted on the four-wheeled vehicle V, but the present invention is not limited thereto. The power supply system according to the present invention may be applied to not only the four-wheeled vehicle V, but also mobile bodies such as a saddled vehicle, a ship, a robot, and an unmanned aircraft which move by a propulsive force generated by a rotary electrical machine.

The vehicle V includes drive wheels W, a drive motor M as a rotary electrical machine coupled to the drive wheels W; and the power supply system 1 which transfers power between the drive motor M and a first battery B1 and a second battery B2 described later. It should be noted that the present embodiment will be described based on an example in which the vehicle V accelerates and decelerates with the motive power generated mainly by the drive motor M; however, the present invention is not to be limited thereto. The vehicle V may be configured as a so-called hybrid vehicle equipped with the drive motor M and an engine as the motive power generation sources.

The drive motor M is coupled to the drive wheels W via a power transmission mechanism (not shown). The drive motor M generates torque by receiving three-phase alternating current power supplied from the power supply system 1. The generated torque is transmitted to the drive wheels W via the power transmission mechanism (not shown) to cause the drive wheel W to rotate and the vehicle V to move. In addition, the drive motor M performs a function as a generator during deceleration of the vehicle V, generates regenerative electric power, and provides the drive wheels W with regenerative braking torque corresponding to the magnitude of this regenerative electric power. The regenerative electric power generated by the drive motor M is charged to the batteries B1, B2 of the power supply system 1 as appropriate.

The power supply system 1 includes a first power circuit 2 to which the first battery B1 is connected, a second power circuit 3 to which the second battery B2 is connected, a voltage converter 5 which connects the first power circuit 2 to the second power circuit 3, a load circuit 4 including various electrical loads including the drive motor M, a cooling circuit 9 for cooling the first battery B1 and the second battery B2, and an electronic control unit group 7 which controls, for example, flow of power in the power circuits 2, 3, and 4, charging/discharging of the batteries B1 and B2, and cooling output of the cooling circuit 9 by operating the power circuits 2, 3, and 4, the cooling circuit 9, and the voltage converter 5. The electronic control unit group 7 includes a management ECU 71, a motor ECU 72, a converter ECU 73, a first battery ECU 74, a second battery ECU 75, and a cooling circuit ECU 76 which are each a computer.

The first battery B1 is a secondary battery capable of both discharging which converts chemical energy into electrical energy, and charging which converts the electrical energy into chemical energy. In the following, a case is described in which a so-called lithium-ion storage battery which performs charging/discharging by means of lithium ions moving between electrodes is employed as the first battery B1; however, the present invention is not limited thereto.

The first battery B1 is provided with a first battery sensor unit 81 for estimating an internal state of the first battery B1. The first battery sensor unit 81 includes a plurality of sensors that detect physical quantities required for the first battery ECU 74 to acquire a charge rate of the first battery B1 (an amount of electricity stored in the battery expressed as a percentage) corresponding to a battery level of the first battery B1 and a temperature of the first battery B1. The plurality of sensors transmit signals corresponding to the detection values to the first battery ECU 74. More specifically, the first battery sensor unit 81 includes, for example, a voltage sensor that detects a terminal voltage of the first battery B1, a current sensor that detects an electrical current flowing in the first battery B1, and a temperature sensor that detects a temperature of the first battery B1.

The second battery B2 is a secondary battery capable of both discharging that converts chemical energy into electrical energy, and charging that converts electrical energy into chemical energy. In the following, a case is described in which a so-called lithium-ion battery which performs charging/discharging by way of lithium ions moving between electrodes is employed as the second battery B2; however, the present invention is not limited thereto. The second battery B2 may be configured as, for example, a capacitor.

The second battery B2 is provided with a second battery sensor unit 82 for estimating an internal state of the second battery B2. The second battery sensor unit 82 includes a plurality of sensors that detect physical quantities required for the second battery ECU 75 to acquire a charge rate, a temperature, etc. of the second battery B2. The plurality of sensors transmit signals corresponding to the detection values to the second battery ECU 75. More specifically, the second battery sensor unit 82 include, for example, a voltage sensor that detects a terminal voltage of the second battery B2, a current sensor that detects an electrical current flowing in the second battery B2, and a temperature sensor that detects a temperature of the second battery B2.

Here, the characteristics of the first battery B1 are compared with the characteristics of the second battery B2. The first battery B1 has a lower-output weight density and a higher-energy weight density than the second battery B2. In addition, the first battery B1 has a larger discharge capacity than the second battery B2. In other words, the first battery B1 is superior to the second battery B2 in terms of energy weight density. The energy-weight density refers to an amount of electric power per unit weight (Wh/kg), and the output-weight density refers to electric power per unit weight (W/kg). Therefore, the first battery B1 that excels in the energy-weight density is a capacitance-type electrical storage device with high capacity as its main purpose, whereas the second battery B2 that excels in output-weight density is an output-type electrical storage device with high output as its main purpose. For this reason, the power supply system 1 uses the first battery B1 as the main power source, and uses the second battery B2 as an auxiliary power source which supplements the first battery B1. Further, the second battery B2 has a smaller heat capacity than the first battery B1. Therefore, the temperature of the second battery B2 rises more rapidly than that of the first battery B1.

The first power circuit 2 includes: the first battery B1, first power lines 21p and 21n which connect a positive electrode and a negative electrode of the first battery B1 to a positive terminal and a negative terminal of a high-voltage side of the voltage converter 5, and a positive contactor 22p and a negative contactor 22n provided to the first power lines 21p and 21n.

The contactors 22p, 22n are of a normal open type which open in a state in which a command signal from outside is not being inputted and electrically disconnect both electrodes of the first battery B1 from the first power lines 21p, 21n and which close in a state in which a command signal is being inputted and connect the first battery B1 to the first power lines 21p, 21n. The contactors 22p, 22n open/close in response to a command signal transmitted from the first battery ECU 74. The positive contactor 22p is a pre-charge contactor having a pre-charge resistance for reducing the inrush current to a plurality of smoothing capacitors provided to the first power circuit 2, the load circuit 4, etc.

The second power circuit 3 includes: the second battery B2, second power lines 31p, 31n which connect a positive electrode and a negative electrode of the second battery B2 to a positive terminal and a negative terminal of a low-voltage side of the voltage converter 5, a positive contactor 32p and a negative contactor 32n provided to the second power lines 31p, 31n, and a current sensor 33 provided to the second power line 31p.

The contactors 32p, 32n are of a normal-open type which open in a state in which a command signal from outside is not being inputted and electrically disconnect both electrodes of the second battery B2 from the second power lines 31p, 31n, and which close in a state in which a command signal is being inputted and connect the second battery B2 to the second power lines 31p, 31n. These contactors 32p, 32n open/close in response to a command signal transmitted from the second battery ECU 75. The positive contactor 32p is a pre-charge contactor having a pre-charge resistance for reducing an inrush current to a plurality of smoothing capacitors provided to the first power circuit 2, the load circuit 4, etc.

The electric current sensor 33 transmits, to the converter ECU 73, a detection signal corresponding to a value of a passing current, which is the electrical current flowing through the second power line 31p, i.e., the electrical current flowing through the voltage converter 5. It should be noted that, in the present embodiment, a direction of the passing current from the second power circuit 3 to the first power circuit 2 is defined as a positive, and a direction of the passing current from the first power circuit 2 to the second power circuit 3 is defined as a negative. In other words, the passing current that passes through the voltage converter 5 becomes positive when the second battery B2 discharges, and becomes negative when the second battery B2 is charged.

The load circuit 4 includes: a vehicle accessory 42, the power converter 43 to which the drive motor M is connected, and load power lines 41p, 41n which connect the vehicle accessory 42 and power converter 43 to the first power circuit 2.

The vehicle accessory 42 is constituted by a plurality of electrical loads, such as a battery heater, an air compressor, a DC-DC converter, and an onboard charger. The vehicle accessory 42 Is connected to the first power lines 21p, 21n of the first power circuit 2 via the load power lines 41p, 41n, and operates by consuming the electric power of the first power lines 21p, 21n. The information regarding operating states of the various electrical loads constituting the vehicle accessory 42 is transmitted to, for example, the management ECU 71.

The power converter 43 is connected, via the load power lines 41p, 41n, to the first power lines 21p, 21n parallel with the vehicle accessory 42. The power converter 43 converts the electric power between the first power lines 21p, 21n and the drive motor M. The power converter 43 is, for example, a PWM inverter based on pulse width modulation and provided with a bridge circuit constituted by a plurality of switching elements (e.g., IGBTs) that are bridge connected, and has a function of performing conversion between DC power and AC power. The power converter 43 has a DC I/O side connected to the first power lines 21p, 21n, and an AC I/O side connected to each coil of the U phase, V phase and W phase of the drive motor M. The power converter 43 converts the DC power of the first power lines 21p, 21n into three-phase AC power and supplies it to the drive motor M, and converts the three-phase AC power supplied from the drive motor M into DC power and supplies it to the first power lines 21p 21n, by ON/OFF driving the switching elements of the respective phases in accordance with a gate drive signal generated at a predetermined timing by a gate drive circuit (not shown) of the motor ECU 72.

The voltage converter 5 connects the first power circuit 2 to the second power circuit 3, and converts the voltage between the circuits 2, 3. The voltage converter 5 includes a known boost circuit.

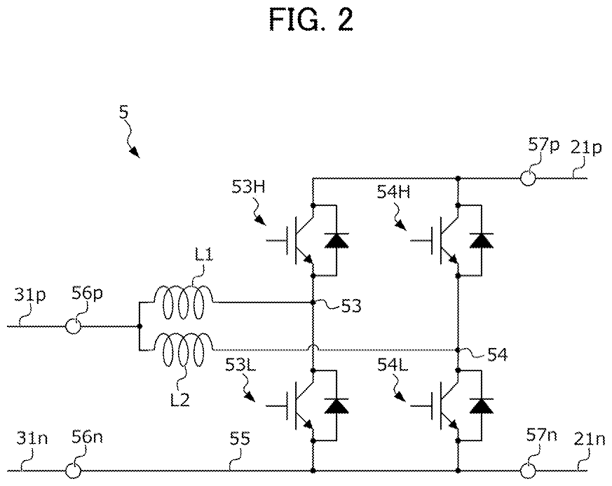

FIG. 2 is a diagram showing an example of the circuit configuration of the voltage converter 5. The voltage converter 5 connects the first power lines 21p, 21n to which the first battery B1 is connected, to the second power lines 31p, 31n to which the second battery B2 is connected, and converts the voltage between these first power lines 21p, 21n and the second power lines 31p, 31n. The voltage converter 5 is a full-bridge DC-DC converter configured by combining a first reactor L1, a second reactor L2, a first high-arm element 53H, a first low-arm element 53L, a second high-arm element 54H, a second low-arm element 54L, a negative bus 55, low-voltage side terminals 56p, 56n, high-voltage side terminals 57p, 57n, and a smoothing capacitor (not shown).

The low-voltage side terminals 56p, 56n are connected to the second power lines 31p, 31n, and the high-voltage side terminals 57p, 57n are connected to the first power lines 21p, 21n. The negative bus 55 is wiring connecting the low-voltage side terminal 56n to the high-voltage side terminal 57n.

The first reactor L1 has one end connected to the low-voltage side terminal 56p, and the other end connected to a connection node 53 between the first high-arm element 53H and the first low-arm element 53L. The first high-arm element 53H and the first low-arm element 53L each include a known power switching element such as an IGBT or a MOSFET, and a freewheeling diode connected to the power switching element. The high-arm element 53H and the low-arm element 53L are connected in this order in series between the high-voltage side terminal 57p and the negative bus 55.

A collector of the power switching element of the first high-arm element 53H is connected to the high-voltage side terminal 57p, and the emitter thereof is connected to a collector of the first low-arm element 53L. An emitter of the power switching element of the first low-arm element 53L is connected to the negative bus 55. The forward direction of the freewheeling diode provided to the first high-arm element 53H is a direction from the first reactor L1 towards the high-voltage side terminal 57p. The forward direction of the freewheeling diode provided to the first low-arm element 53L is a direction from the negative bus 55 towards the first reactor L1.

The second reactor L2 has one end connected to the low-voltage side terminal 56p, and the other end connected to a connection node 54 between the second high-arm element 54H and second low-arm element 54L. The second high-arm element 54H and the second low-arm element 54L each include a known power switching element such as an IGBT or a MOSFET, and a freewheeling diode connected to the power switching element. The high-arm element 54H and the low-arm element 54L are connected in this order in series between the high-voltage side terminal 57p and the negative bus 55.

A collector of the power switching element of the second high-arm element 54H is connected to the high-voltage side terminal 57p, and the emitter thereof is connected to the collector of the second low-arm element 54L. An emitter of the power switching element of the second low-arm element 54L is connected to the negative bus 55. The forward direction of the freewheeling diode provided to the second high-arm element 54H is a direction from the second reactor L2 towards the high-voltage side terminal 57p. The forward direction of the freewheeling diode provided to the second low-arm element 54L is a direction from the negative bus 55 towards the second reactor L2.

The voltage converter 5 converts the voltage between the first power lines 21p, 21n and the second power lines 31p, 31n, by alternately driving ON/OFF the first high-arm element 53H and second low-arm element 54L, and the first low-arm element 53L and second high-arm element 54H, in accordance with the gate drive signal generated at a predetermined timing by a gate drive circuit (not shown) of the converter ECU 73.

The static voltage of the second battery B2 is basically maintained lower than the static voltage of the first battery B1. Therefore, the voltage of the first power lines 21p, 21n is basically higher than the voltage of the second power lines 31p, 31n. Therefore, in a case of driving the drive motor M using both the power outputted from the first battery B1 and the power outputted from the second battery B2, the converter ECU 73 operates the voltage converter 5 to cause the voltage converter 5 perform a boost function. The boost function refers to a function of stepping up the power of the second power lines 31p, 31n to which the low-voltage side terminals 56p, 56n are connected, and outputting the power to the first power lines 21p, 21n to which the high-voltage side terminals 57p, 57n are connected, whereby a positive passing current flows from the second power lines 31p, 31n side to the first power lines 21p, 21n side. In a case where discharge of the second battery B2 is to be reduced and the drive motor M is to be driven by only the power outputted from the first battery B1, the converter ECU 73 turns OFF the voltage converter 5 to prevent electrical current from flowing from the first power lines 21p, 21n to the second power lines 31p, 31n.

In a case where the first battery B1 and/or the second battery B2 is to be charged with the regenerative electric power outputted from the drive motor M to the first power lines 21p, 21n during deceleration, the converter ECU 73 operates the voltage converter 5 to cause the voltage converter 5 to perform a step-down function. The step-down function refers to a function of stepping down the electric power in the first power lines 21p, 21n to which the high-voltage side terminals 57p, 57n are connected, and outputting the power to the second power lines 31p, 31n to which the low-voltage side terminals 56p, 56n are connected, whereby a negative passing current flows from the first power lines 21p, 21n side to the second power lines 31p, 31n side.

Referring back to FIG. 1, the first battery ECU 74 is a computer mainly responsible for monitoring the state of the first battery B1 and for the open/close operation of the contactors 22p, 22n of the first power circuit 2. The first battery ECU 74 calculates, based on a known algorithm using the detection value transmitted from the first battery sensor unit 81, various parameters representing the internal state of the first battery B1, namely, the temperature of the first battery B1 (hereinafter, also referred to as “first battery temperature”), an internal resistance of the first battery B1, the static voltage of the first battery B1, a closed circuit voltage of the first battery B1, a first charge rate corresponding to a charge rate of the first battery B1, and a degree of degradation of the first battery B1. The information regarding the parameters representing the internal state of the first battery 81 acquired by the first battery ECU 74 is transmitted to the management ECU 71, for example.

The second battery ECU 75 is a computer mainly responsible for monitoring of the state of the second battery B2 and for open/close operation of the contactors 32p, 32n of the second power circuit 3. The second battery ECU 75 calculates, based on a known algorithm using the detection value sent from the second battery sensor unit 82, various parameters representing the internal state of the second battery B2, namely, the temperature of the second battery B2 (hereinafter, also referred to as “second battery temperature”), an internal resistance of the second battery B2, the static voltage of the second battery B2, a closed circuit voltage of the second battery B2, a second charge rate corresponding to a charge rate of the second battery B2, and a degree of degradation of the second battery B2. The information regarding the parameters representing the internal state of the second battery B2 acquired by the second battery ECU 75 is transmitted to the management ECU 71, for example.

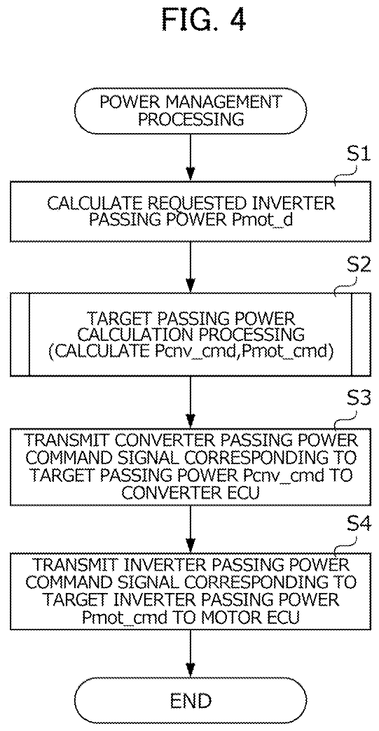

The management ECU 71 is a computer that mainly manages the flow of electric power in the overall power supply system 1. The management ECU 71 generates an inverter passing power command signal corresponding to a command related to inverter passing power, which passing through the power converter 43, and a converter passing power command signal corresponding to a command related to converter passing power, which is passing through the voltage converter 5, by executing the power management processing to be described later with reference to FIG. 4.

The motor ECU 72 is a computer that mainly operates the power converter 43, and controls the flow of power between the first power circuit 2 and the drive motor M, that is, the flow of the inverter passing power. In the following, the inverter passing power is defined as a positive when the power flows from the first power circuit 2 to the drive motor M, that is, when the drive motor M is in power driving. Further, the inverter passing power is defined as a negative when the power flows from the drive motor M to the first power circuit 2, that is, when the drive motor M is in regenerative driving. In response to the inverter passing power command signal transmitted from the management ECU 71, the motor ECU 72 operates the power converter 43 so that the inverter passing power according to the command passes through the power converter 43, that is, the torque according to the inverter passing power is generated by the drive motor M.

The converter ECU 73 is a computer that mainly operates the voltage converter 5, and controls the flow of power between the first power circuit 2 and the second power circuit 3, that is, the flow of the converter passing power. In the following, the converter passing power is defined as a positive when the power flows from the second power circuit 3 to the first power circuit 2, that is, when the second battery B2 discharges and supplies power to the first power circuit 2. The converter passing power is defined as a negative when the power flows from the first power circuit 2 to the second power circuit 3, that is, when the second battery B2 is charged with power from the first power circuit 2. In response to the converter passing power command signal transmitted from the management ECU 71, the converter ECU 73 operates the voltage converter 5 so that the converter passing power according to the command passes through the voltage converter 5. More specifically, the converter ECU 73 calculates, based on the converter passing power command signal, a target current that is a target for the passing current in the voltage converter 5, and operates the voltage converter 5 according to a known feedback control algorithm so that a passing current (hereinafter also referred to as an “actual passing current”) detected by the current sensor 33 becomes equal to the target current.

As described above, in the power supply system 1, the management ECU 71, the motor ECU 72, and the converter ECU 73 operate the voltage converter 5 and the power converter 43 to control the passing power in the voltage converter 5 and the passing power in the power converter 43, thereby enabling control of the first battery output power that is the output power of the first battery B1 and the second battery output power that is the output power of the second battery B2. Accordingly, in the present embodiment, the management ECU 71, the motor ECU 72, and the converter ECU 73 constitute a power controller for controlling the first battery output power and the second battery output power. More specifically, the power controller controls the converter passing power to P2, and controls the inverter passing power to P1+P2, thereby making it possible to control the first battery output power and the second battery output power to P1 and P2, respectively.

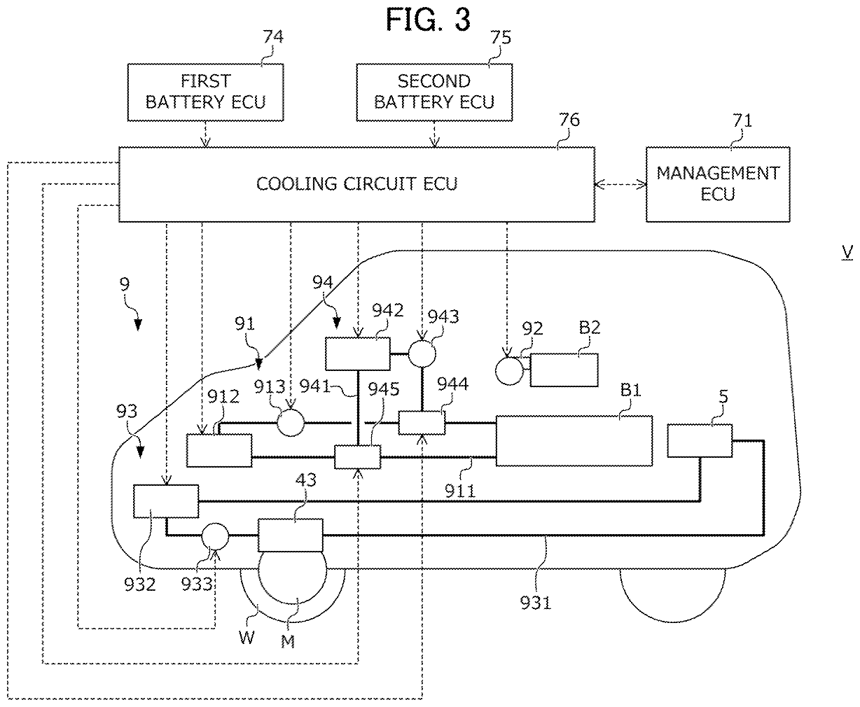

FIG. 3 is a diagram showing a circuit configuration of the cooling circuit 9. The cooling circuit 9 includes a first cooler 91 for cooling the first battery B1, a second cooler 92 for cooling the second batter B2, and a third cooler 93 for cooling the voltage converter 5 and the power converter 43.

The first cooler 91 includes a first cooling water circulating path 911 including a cooling water flow path formed in a battery case that houses the first battery B1, a first heat exchanger 912 and a first cooling water pump 913 provided on the first cooling water circulating path 911, and a heating device 94 connected to the first cooling water circulating path 911.

The first cooling water pump 913 rotates in response to a command inputted from the cooling circuit ECU 76, and circulates cooling water in the first cooling water circulating path 911. The first heat exchanger 912 promotes heat exchange between the cooling water circulating in the first cooling water circulating path 911 and outside air, thereby cooling the cooling water heated by the heat exchange with the first battery B1. The first heat exchanger 912 includes a radiator fan that rotates in response to a command inputted from the cooling circuit ECU 76.

The heating device 94 includes a bypass path 941 that connects an inlet and an outlet of the first heat exchanger 912 of the first cooling water circulating path 911 and bypasses the first heat exchanger 912, a heater 942 and a heating pump 943 provided on the bypass path 941, and three-way valves 944 and 945 at a connection portion between both ends of the bypass path 941 and the first cooling water circulating path 911.

The heating pump 943 rotates in response to a command inputted from the cooling circuit ECU 76, and circulates cooling water in the first cooling water circulating path 911 and the bypass path 941. The heater 942 generates heat by consuming electric power supplied from a battery (not shown), and raises the temperature of the cooling water flowing through the bypass path 941.

The three-way valves 944 and 945 open and close in response to a command from the cooling circuit ECU 76, to switch the flow path of the cooling water between the first heat exchanger 912 side and the heater 942 side. Therefore, the first cooler 91 has two functions: a cooling function of cooling the first battery B1 by circulation of the cooling water cooled by the first heat exchanger 912; and a heating function of heating the first battery B1 by circulation of the cooling water heated by the heater 942.

The cooling circuit ECU 76 controls a first cooling output of the first cooler 91 for the first battery B1 by operating the first heat exchanger 912, the first cooling water pump 913, the heater 942, the heating pump 943, and the three-way valves 944, 945, based on the first battery temperature transmitted from the first battery ECU 74, the detection value of a first cooling water temperature sensor (not shown) for detecting the temperature of the cooling water flowing through the first cooling water circulating path 911, the detection value of an outside temperature sensor (not shown), a command from the management ECU 71, etc. Here, the first cooling output is a parameter that increases or decreases according to cooling performance provided on the first battery B1 by the first cooler 91, and is, for example, the rotation speed of the radiator fan provided in the first heat exchanger 912. A specific procedure for controlling the first cooling output performed by the cooling circuit ECU 76 will be described later.

The second cooler 92 includes, for example, a cooling fan that supplies outside air into a battery case that houses the second battery B2. The second cooler 92 rotates in response to a command from the cooling circuit ECU 76, and supplies the outside air into the battery case of the second battery B2 to cool the second battery B2.

The cooling circuit ECU 76 controls a second cooling output of the second cooler 92 for the second battery B2 by operating the second cooler 92 based on the second battery temperature transmitted from the second battery ECU 75, the detection value of an outside temperature sensor, and a command from the management ECU 71. Here, the second cooling output is a parameter that increases or decreases according to cooling performance provided on the second battery B2 by the second cooler 92, and is, for example, the rotation speed of the cooling fan of the second cooler 92. A specific procedure for controlling the second cooling output performed by the cooling circuit ECU 76 will be described later.

The third cooler 93 includes a third cooling water circulating path 931 including a cooling water flow path formed in a housing in which the voltage converter 5 and the power converter 43 are installed, and a third heat exchanger 932 and a third cooling water pump 933 provided in the third cooling water circulating path 931.

The third cooling water pump 933 rotates in response to a command inputted from the cooling circuit ECU 76, and circulates cooling water in the third cooling water circulating path 931. The third heat exchanger 932 promotes heat exchange between the cooling water circulating in the third cooling water circulating path 931 and outside air, thereby cooling the cooling water heated by the heat exchange with the voltage converter 5 and the power converter 43. The third heat exchanger 932 includes a radiator fan that rotates in response to a command inputted from the cooling circuit ECU 76.

The cooling circuit ECU 76 operates the third heat exchanger 932 and the third cooling water pump 933 based on the detection value of a cooling water temperature sensor (not shown) and a command from the management ECU 71, and thereby controls the third cooling output corresponding to cooling performance provided on the voltage converter 5 and the power converter 43 by the third cooler 93.

In the present embodiment, as described above, the first cooler 91 for cooling the first battery B1 and the third cooler 93 for cooling the voltage converter 5, etc. are of a water cooling type in which the cooling is performed by heat exchange with the cooling water, and the second cooler 92 for cooling the second battery B2 having a smaller heat capacity than the first battery B1 is of an air cooling type in which the cooling is performed by heat exchange with the outside air; however, the present invention is not limited thereto. The first cooler 91 may be configured as the air cooling type, the second cooler 92 may be configured as the water cooling type, and the third cooler 93 may be configured as the air cooling type. In the present embodiment, the circulation flow path of the cooling water for cooling the first battery B1 and the circulation flow path of the cooling water for cooling the voltage converter 5 and the power converter 43 are configured as separate systems, but the present invention is not limited thereto. Both or either of the voltage converter 5 and the power converter 43 may be cooled by the cooling water for cooling the first battery B1.

FIG. 4 is a flowchart showing a specific procedure of the power management processing. The power management processing is repeatedly executed in predetermined cycles in the management ECU 71 from the time when the driver turns on a start switch (not shown) to start operating the vehicle V and the power supply system 1 to the time when the driver then turns off the start switch to stop the operation of the vehicle V and the power supply system 1.

First, in Step S1, the management ECU 71 calculates a requested drive torque by the driver based on the operation amount of the pedals such as the accelerator pedal and brake pedal (see FIG. 1) by the driver, and converts the requested drive torque into power, thereby calculating a request for the inverter passing power in the power converter 43, that is, a requested inverter passing power Pmot_d corresponding to the requested output in the drive motor M, and then, the management ECU 71 proceeds to Step S2.

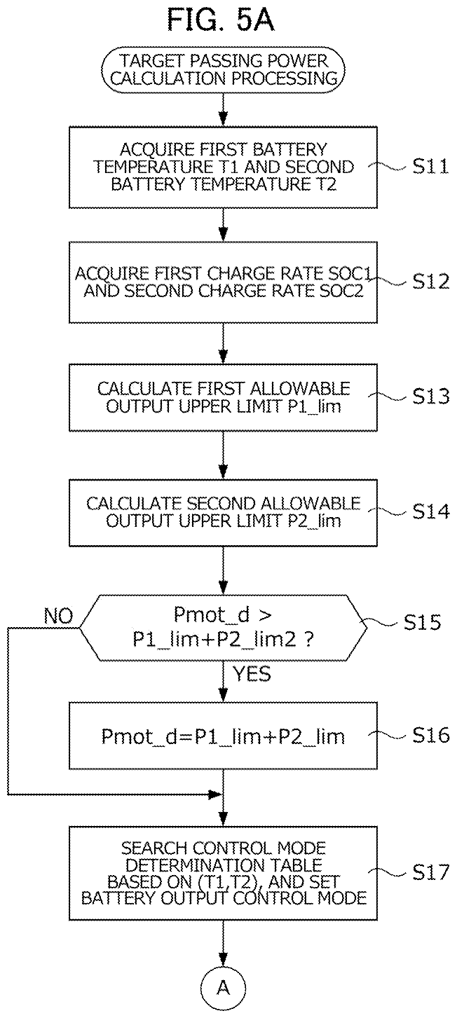

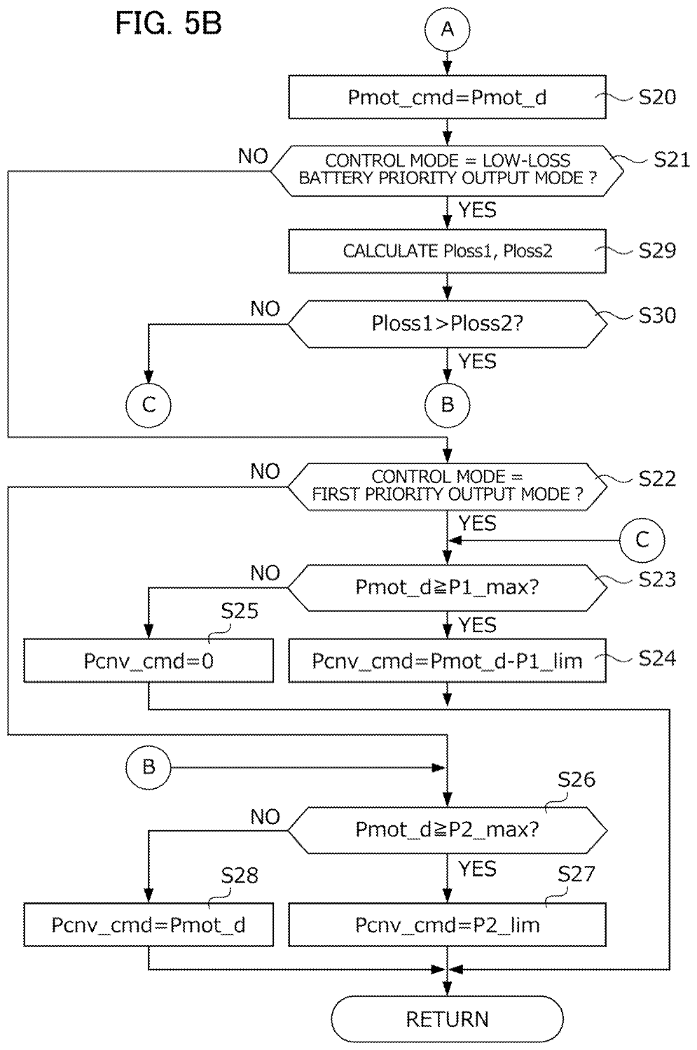

Next, in Step S2, the management ECU 71 executes, based on the requested inverter passing power Pmot_d calculated in Step S1, target passing power calculation processing, which will be described later with reference to FIGS. 5A and 5B to calculate a target converter passing power Pcnv_cmd corresponding to the target for the converter passing power and a target inverter passing power Pmot_cmd corresponding to the target for the inverter passing power. Thereafter, the management ECU 71 proceeds to Step S3.

Next, in Step S3, the management ECU 71 generates a converter passing power command signal corresponding to the target converter passing power Pcnv_cmd and transmits the generated signal to the converter ECU 73, and then, proceeds to Step S8. Thus, the power corresponding to the target converter passing power Pcnv_cmd is charged and discharged from the second battery B2.

Next, in Step S4, the management ECU 71 generates an inverter passing power command signal corresponding to the target inverter passing power Pmot_cmd and transmits the generated signal to the motor ECU 72, and the processing of FIG. 4 ends. Thus, the power corresponding to the target inverter passing power Pmot_cmd flows between the first power circuit 2 and the drive motor M. As a result, the power obtained by subtracting the target converter passing power Pcnv_cmd from the target inverter passing power Pmot_cmd is charged and discharged from the first battery B1.

FIGS. 5A and 5B are flowcharts showing a specific procedure of the target passing power calculation processing.

First, in Step S11, the management ECU 71 acquires the first battery temperature T1 and the second battery temperature T2 from the first battery ECU 74 and the second battery ECU 75, respectively, and then, proceeds to Step S12.

Next, in Step S12, the management ECU 71 acquires the first charge rate SOC1 and the second charge rate SOC2 from the first battery ECU 74 and the second battery ECU 75, respectively, and then, proceeds to Step S13.

Next, in Step S13, the management ECU 71 searches a predetermined map based on the first battery temperature T1 and the first charge rate SOC1 acquired in Steps S11 and S12 to calculate a first allowable output upper limit P1_lim corresponding to the upper limit of the output power allowed for the current first battery B1, and then, proceeds to Step S14.

Next, in Step S14, the management ECU 71 searches a predetermined map based on the second battery temperature T2 and the second charge rate SOC2 acquired in Steps S11 and S12 to calculate a second allowable output upper limit P2_lim corresponding to the upper limit of the output power allowed for the current second battery B2, and then, proceeds to Step S15.

Next, in Step S15, the management ECU 71 determines whether the requested inverter passing power Pmot_d acquired in Step S1 is equal to or more than the sum of the first allowable output upper limit P1_lim and the second allowable output upper limit P2_lim (that is, the upper limit of the output power allowed for all the batteries including the first battery B1 and the second battery B2). When the determination result in Step S15 is YES, the management ECU 71 proceeds to Step S16, and performs limit processing for limiting the requested inverter passing power Pmot_d to the sum of the first allowable output upper limit P1_lim and the second allowable output upper limit P2_lim or less, and then, proceeds to Step S17. More specifically, the management ECU 71 limits the requested inverter passing power Pmot_d by redefining the sum of the first allowable output upper limit P1_lim and the second allowable output upper limit P2_lim as the requested inverter passing power Pmot_d. When the determination result in Step S15 is NO, the management ECU 71 proceeds to Step S17 without executing the limit processing of Step S16.

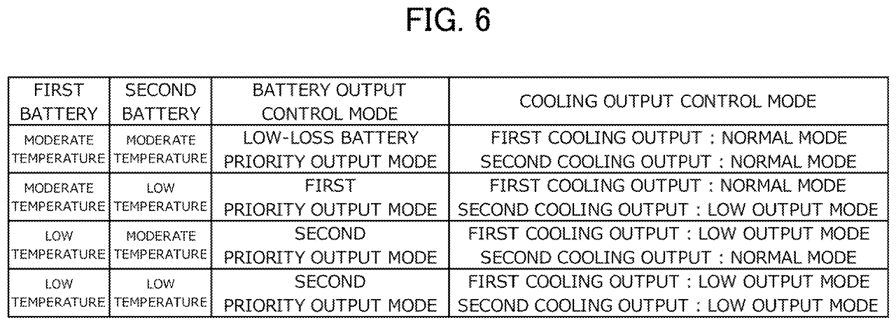

Next, in Step S17, the management ECU 71 sets a battery output control mode according to the temperature states of the current first and batteries B1 and B2 by searching the control mode determination table as exemplified in FIG. 6 based on the first battery temperature T1 and the second battery temperature T2 acquired in Step S11, and then, proceeds to Step S20.

FIG. 6 shows an example of the control mode determination table. As shown in FIG. 6, the management ECU 71 can set the battery output control mode to a first priority output mode, second priority output mode, or a low loss battery priority output mode.

In FIG. 6, in respect of the first battery B1, “MODERATE TEMPERATURE” means a state in which the first battery temperature T1 is equal to or higher than a predetermined first temperature reference value T1bs, and “LOW TEMPERATURE” means a state in which the first battery temperature T1 is lower than the first temperature reference value T1bs. Further, in respect of the second battery B2, “MODERATE TEMPERATURE” means a state in which the second battery temperature T2 is equal to or higher than a predetermined second temperature reference value T2bs, and “LOW TEMPERATURE” means a state in which the second battery temperature T2 is lower than the second temperature reference value T2bs. Here, the first temperature reference value T1bs is set, for example, within a target temperature range of the first battery B1 in which output characteristics of the first battery B1 are most favorable: more specifically, to a lower limit value of the target temperature range. Further, the second temperature reference value T2bs is set, for example, within a target temperature range of the second battery B2 in which output characteristics of the second battery B2 are most favorable: more specifically, to a lower limit value of the target temperature range.

When setting the battery output control mode to the first priority output mode, the management ECU 71 increases the output power of the first battery B1 up to the first allowable output upper limit P1_lim in preference to the second battery B2. In other words, when the requested inverter passing power Pmot_d does not exceed the first allowable output upper limit P1_lim, the management ECU 71 calculates the target converter passing power Pcnv_cmd and the target inverter passing power Pmot_cmd such that the requested inverter passing power Pmot_d is entirely covered by the first battery B1. When the requested inverter passing power Pmot_d exceeds to the first allowable output upper limit P1_lim, the management ECU 71 calculates the target converter passing power Pcnv_cmd and the target inverter passing power Pmot_cmd such that the shortage is covered by the second battery B2.

When setting the battery output control mode to the second priority output mode, the management ECU 71 increases the output power of the second battery B2 up to the second allowable output upper limit P2_lim in preference to the first battery B1. In other words, when the requested inverter passing power Pmot_d does not exceed the second allowable output upper limit P2_lim, the management ECU 71 calculates the target converter passing power Pcnv_cmd and the target inverter passing power Pmot_cmd such that the requested inverter passing power Pmot_d is entirely covered by the second battery B2. When the requested inverter passing power Pmot_d exceeds to the second allowable output upper limit P2_lim, the management ECU 71 calculates the target converter passing power Pcnv_cmd and the target inverter passing power Pmot_cmd such that the shortage is covered by the first battery B1.

When setting the battery output control mode to the low loss battery priority output mode, the management ECU 71 compares a loss that is caused in the overall power supply system 1 when the first battery B1 preferentially outputs power with a loss that is caused in the overall power supply system 1 when the second battery B2 preferentially outputs power, as will be described below. Based on this comparison, the management ECU 71 causes one of the batteries that has the lower loss to output in preference to the other.

According to the control mode determination table exemplified in FIG. 6, when the first battery B1 is at the moderate temperature and the second battery B2 is at a low temperature (T1≥T1bs and T2<T2bs), the management ECU 71 sets the battery output control mode to the first priority output mode such that the power is preferentially outputted from the first battery B1 having the moderate temperature and a small loss. When the first battery B1 is at the low temperature and the second battery B2 is at the moderate temperature (T1<T1bs and T2≥T2bs), the management ECU 71 sets the battery output control mode to the second priority output mode such that the power is preferentially outputted from the second battery B2 having the moderate temperature and a small loss.

When the first battery B1 and the second battery B2 are both at the moderate temperature (T1≥T1bs and T2≥T2bs), the management ECU 71 sets the battery output control mode to the low loss battery priority output mode. When the first battery B1 and the second battery B2 are both at the low temperature (T1<T1bs and T2<T2bs), that is, when it is presumed that a large loss is caused regardless of which battery is used, the management ECU 71 sets the battery output control mode to the second priority output mode such that the power is preferentially outputted from the second battery B2 having a smaller heat capacity and capable of rapidly raising the temperature.

Returning to FIG. 5B, in Step S20, the management ECU 71 sets the requested inverter passing power Pmot_d as the target inverter passing power Pmot_cmd, and then, proceeds to Step S21.

Next, in Step S21, the management ECU 71 determines whether the battery output control mode set in Step S17 is the low loss battery priority output mode. When the determination result in Step S21 is NO, the management ECU 71 proceeds to Step S22.

In Step S22, the management ECU 71 determines whether the battery output control mode set in Step S17 is the first priority output mode. When the determination result in Step S22 is YES, the management ECU 71 proceeds to Step S23.

In Step S23, the management ECU 71 determines whether the requested inverter passing power Pmot_d is equal to or more than the first allowable output upper limit P1_lim. When the determination result in Step S23 is YES, the management ECU 71 proceeds to Step S24, sets a value that is obtained by subtracting the first allowable output upper limit P1_lim from the requested inverter passing power Pmot_d, as the target converter passing power Pcnv_cmd so as to compensate for the shortage of the first battery B1 with the second battery B2, and then, ends the target passing power calculation processing. When the determination result in Step S23 is NO, the management. ECU 71 proceeds to Step S25, set a value of 0 as the target converter passing power Pcnv_cmd, and then, ends the target passing power calculation processing.

When the determination result in Step S22 is NO, that is, when the battery output control mode is the second priority output mode, the management ECU 71 proceeds to Step 26. In Step S26, the management ECU 71 determines whether the requested inverter passing power Pmot_d is equal to or more than the second allowable output upper limit P2_lim. When the determination result in Step S26 is YES, the management ECU 71 proceeds to Step S27, sets the second allowable output upper limit P2_lim as the target converter passing power Pcnv_cmd, and the, ends the target passing power calculation processing. When the determination result in Step S26 is NO, the management ECU 71 proceeds to Step S28, sets the requested inverter passing power Pmot_d as the target converter passing power Pcnv_cmd, and then, ends the target passing power calculation processing.

When the determination result in Step S21 is YES, that is, when the battery output control mode is the low loss battery priority output mode, the management ECU 71 proceeds to Step S29.

In Step S29, the management ECU 71 calculates a first loss Ploss1 corresponding to a loss that is caused in the first battery B1, the second battery B2, and the voltage converter 5 when the battery output control mode is set to the first priority output control mode, and a second loss Ploss2 corresponding to a loss that is caused in the first battery B1, the second battery B2, and the voltage converter 5 when the battery output control mode is set to the second priority output control mode, and then, proceeds to Step S30.

More specifically, first, the management ECU 71 acquires the temperature, the internal resistance, the charge rate, and the degree of degradation of each of the first battery B1 and the second battery B2 from the first battery ECU 74 and the second battery ECU 75, respectively. Next, the management ECU 71 calculates the power that is outputted from each of the batteries B1 and B2 and the power that passes through the voltage converter 5 in the case where the battery output control mode is set to the first priority output control mode, and then, calculates the first loss Ploss1 by using these kinds of power and the temperature, the internal resistance, the charge rate, and the degree of degradation that have been acquired. Further, the management ECU 71 calculates the power that is outputted from each of the batteries B1 and B2 and the power that passes through the voltage converter 5 in the case where the battery output control mode is set to the second priority output mode, and then, calculates the second loss Ploss2 by using these kinds of power and the temperature, the internal resistance, the charge rate, and the degree of degradation that have been are acquired.

In Step S30, the management ECU 71 determines whether the first loss Ploss1 is larger than the second loss Ploss2. When the determination result in Step S30 is YES, the management ECU 71 proceeds to Step S26 in order to set the battery output control mode to the second priority output mode with a lower loss; when the determination is NO, the management ECU 71 proceeds to Step S23 in order to set the battery output control mode to the first priority output mode with a lower loss.

Returning back to FIG. 3, a procedure for controlling the first cooling output and the second cooling output performed by the cooling circuit ECU 76 will be described.

The cooling circuit ECU 76 switches between the cooling output control modes for controlling the first and second cooling outputs based on the first battery temperature T1 and the second battery temperature T2. As shown in FIG. 6, the cooling circuit ECU 76 can independently set the cooling output control mode of the first cooling output and the cooling output control mode of the second cooling output to either a normal mode or a low-output mode.

According to the control mode determination table exemplified in FIG. 6, the management ECU 71 sets the cooling output control mode of the first cooling output to the normal mode when the first battery B1 is at the moderate temperature (T1≥T1bs), and sets the cooling output control mode of the first cooling output to the low-output mode when the first battery B1 is at the low temperature (T1<T1bs). The management ECU 71 sets the cooling output control mode of the second cooling output to the normal mode when the second battery B2 is at the moderate temperature (T2≥T2bs), and sets the cooling output control mode of the second cooling output to the low-output mode when the second battery B2 is at the low temperature (T2<T2bs).

First, a case where the cooling output control mode is set to the normal mode will be described. When the cooling output control mode of the first cooling output is set to the normal mode, the cooling circuit ECU 76 calculates a first control input (for example, a duty ratio of the motor for driving the radiator fan) with respect to the first cooler 91, based on a known first basic cooling algorithm using the first battery temperature transmitted from the first battery ECU 74, the detection value of the first cooling water temperature sensor, and the detection value of the outside air temperature sensor, such that the first battery temperature is at the predetermined first target temperature defined within the target temperature range of the first battery B1, and controls the first cooling output by inputting the first control input to the first cooler 91.

Further, when the cooling output control mode of the second cooling output is the normal mode, the cooling circuit ECU 76 calculates a second control input (for example, a duty ratio of the motor for driving the cooling fan) to the second cooler 92, based on a known second basic cooling algorithm using the second battery temperature transmitted from the second battery ECU 75 and the detection value of the outside air temperature sensor, such that the second battery temperature is at the second target temperature defined within the target temperature range of the second battery B2, and controls the second cooling output by inputting the second control input to the second cooler 92.

Next, a case where the cooling output control mode is set to the low-output mode will be described. When the cooling output control mode of the first cooling output is set to the low-output mode, the cooling circuit ECU 76 corrects the first control input to cooling performance deterioration by subtracting a predetermined correction value from the first control input calculated based on the above-described first basic cooling algorithm, and inputs the corrected first control input to the first cooler 91 to control the first cooling output. For this reason, the cooling circuit ECU 76 reduces the first cooling output when the first battery B1 is at the low temperature, as compared with the case of the first battery B1 being at the moderate temperature.

Further, When the cooling output control mode of the second cooling output is the low-output mode, the cooling circuit ECU 76 corrects the second control input to cooling performance deterioration by subtracting a predetermined correction value from the second control input calculated based on the above-described second basic cooling algorithm, and inputs the corrected second control input to the second cooler 92 to control the second cooling output. For this reason, the cooling circuit ECU 76 reduces the second cooling output when the second battery B2 is at the low temperature, as compared with the case of the second battery B2 being at the moderate temperature.

The power supply system 1 according to the present embodiment exerts the following effects.

(1) In the power supply system 1, based on the first battery temperature T1 and the second battery temperature T2, the management ECU 71 switches the battery output control mode between the first priority output mode in which the output power of the first battery B1 is increased up to the first allowable output upper limit P1_lim in preference to that of the second battery B2 and the second priority output mode in which the output power of the second battery B2 is increased up to the second allowable output upper limit P2_lim in preference to that of the first battery B1. Therefore, according to the power supply system 1, the battery to be used preferentially can be switched such that the circuit losses in the entire power supply system 1 are reduced. Further, reduction of the circuit losses makes it possible to lengthen the travelable distance of the vehicle V.

(2) In the case where the first battery temperature T1 is lower than the first temperature reference value T1bs, the cooling circuit ECU 76 reduces the first cooling output of the first cooler 91 as compared with the case where the first battery temperature T1 is equal to or higher than the first temperature reference value T1bs. In the case where the second battery temperature T2 is lower than the second temperature reference value T2bs, the cooling circuit ECU 76 reduces the second cooling output by the second cooler 92 as compared with the case where the second battery temperature T2 is equal to or higher than the second temperature reference value T2bs. Due to this feature, each of the first battery temperature T1 and the second battery temperature T2 can be rapidly increased, and the power consumption of the coolers 91 and 92 can be reduced, whereby the travelable distance of the vehicle V can be further lengthened.

(3) When the first battery temperature T1 is equal to or higher than the first temperature reference value T1bs and the second battery temperature T2 is lower than the second temperature reference value T2bs, the management ECU 71 sets the battery output control mode to the first priority output mode, thereby preferentially causing the first battery B1 having the moderate temperature to discharge. Thus, the circuit loss can be reduced as compared with the case where the second battery B2 having a relatively low temperature is preferentially caused to discharge. Further, when the first battery temperature T1 is lower than the first temperature reference value T1bs and the second battery temperature T2 is equal to or higher than the second temperature reference value T2bs, the management ECU 71 sets the battery output control mode to the second priority output mode, thereby preferentially causing the second battery B2 having the moderate temperature to discharge. Thus, the circuit loss can be reduced as compared with the case where the first battery B1 having a relatively low temperature is preferentially caused to discharge.

(4) The management ECU 71 acquires the first loss Ploss1 when the battery output control mode is set to the first priority output mode and the second loss Ploss2 when the battery output control mode is set to the second priority output mode. Further, in the case where the first battery temperature T1 is equal to or higher than the first temperature reference value T1bs and the second battery temperature T2 is equal to or higher than the second temperature reference value T2bs, the management ECU 71 sets the battery output control mode to the second priority output mode leading to a low loss when the first loss Ploss1 is larger than the second loss Ploss2, and sets the battery output control mode to the first priority output mode leading to a lower loss when the second loss Ploss2 is larger than the first loss Ploss1. This feature makes it possible to further reduce the circuit losses in the power supply system 1.

(5) In the case where the first battery temperature T1 is lower than the first temperature reference value T1bs and the second battery temperature T2 is lower than the second temperature reference value T2bs, the management ECU 71 sets the battery output control mode to the second priority output mode, and preferentially causes the second battery B2 having a relatively small heat capacity to discharge. Due to this feature, the temperature of the second battery B2 can be rapidly increased, and thus the circuit losses in the power supply system 1 can be further reduced.

### Second Embodiment

Next, a power supply system according to a second embodiment of the present invention will be described with reference to the drawings. The power supply system according to the present embodiment is different from the power supply system 1 according to the first embodiment in terms of the configuration of the control mode determination table.

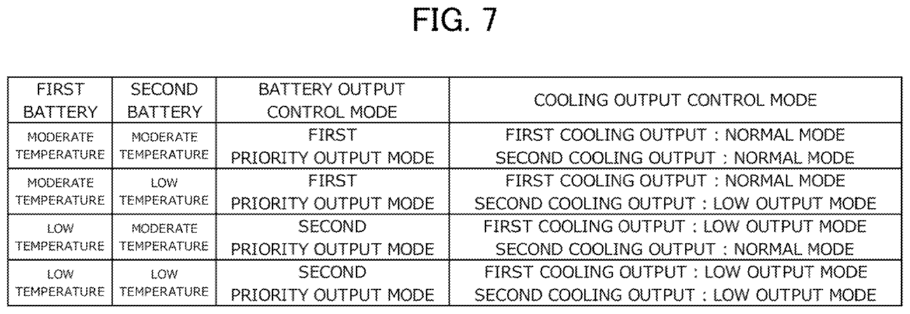

FIG. 7 is a table showing an example of a control mode determination table referred to in the power supply system according to the present embodiment. The control mode determination table shown in FIG. 7 is different from the control mode determination table shown in FIG. 6 in terms of the battery output control mode in the case where all of the first battery B1 and the second battery B2 are at the moderate temperature.

According to the control mode determination table exemplified in FIG. 7, the management ECU sets the battery output control mode to the first priority output mode when all of the first battery B1 and the second battery B2 are at the moderate temperature (T1≥T1bs and T2≥T2bs).

According to the power supply system related to the present embodiment, the following effects are obtained.

(6) In the power supply system, the first battery B1 is connected to the drive motor M via the power converter 43, and the second battery B2 is connected to the drive motor M via the power converter 43 and the voltage converter 5. Therefore, assuming that the circuit loss in the first battery B1 is equal to the circuit loss in the second battery B2, since more power passes through the voltage converter 5 in the second priority output mode than in the first priority output mode, the loss is larger in the second priority output mode than in the first priority output mode. Therefore, when the first battery temperature T1 is equal to or higher than the first temperature reference value T1bs and the second battery temperature T2 is equal to or higher than the second temperature reference value T2bs, the management ECU sets the battery output control mode to the first priority output mode leading to a lower loss. This feature makes it possible to further reduce the circuit losses in the power supply system.

Although an embodiment of the present invention has been described above, the present invention is not limited thereto. The configurations of detailed parts may be modified as appropriate within the scope of the gist of the present invention.

What is claimed is:

1. A power supply system comprising:
a first electrical storage device;
a second electrical storage device;
a load circuit including a rotary electrical machine;
a power circuit that connects the first and second electrical storage devices to the load circuit; and
a power controller that controls output power of the first electrical storage device and output power of the second electrical storage device by operating the power circuit,
the power supply system further comprising:
a temperature acquirer that acquires a first temperature as a temperature of the first electrical storage device and a second temperature as a temperature of the second electrical storage device; and
an allowable output upper limit acquirer that acquires a first allowable output upper limit for the output power of the first electrical storage device and a second allowable output upper limit for the output power of the second electrical storage device,
the power controller being configured to switch, based on the first temperature and the second temperature, a control mode between a first priority output mode in which the output power of the first electrical storage device is increased up to the first allowable output upper limit in preference to that of the second electrical storage device and a second priority output mode in which the output power of the second electrical storage device is increased up to the second allowable output upper limit in preference to that of the first electrical storage device.

2. The power supply system according to claim 1, further comprising:
a cooling circuit that cools the first electrical storage device and the second electrical storage device; and
a cooling output controller that controls a first cooling output for the first electrical storage device by the cooling circuit and a second cooling output for the second electrical storage device by the cooling circuit,
wherein in a case where the first temperature is lower than a first temperature reference value, the cooling output controller reduces the first cooling output as compared with a case where the first temperature is equal to or higher than the first temperature reference value, and
wherein in a case where the second temperature is lower than a second temperature reference value, the cooling output controller reduces the second cooling output as compared with a case where the second temperature is equal to or higher than the second temperature reference value.

3. The power supply system according to claim 2,
wherein the power controller sets the control mode to the first priority output mode in a case where the first temperature is equal to or higher than the first temperature reference value and the second temperature is lower than the second temperature reference value, and
wherein the power controller sets the control mode to the second priority output mode in a case where the first temperature is lower than the first temperature reference value and the second temperature is equal to or higher than the second temperature reference value.

4. The power supply system according to claim 3, further comprising a loss acquirer that acquires a first loss and a second loss, the first loss being caused in the first electrical storage device and the power circuit when the control mode is set to the first priority output mode, the second loss being caused in the second electrical storage device and the power circuit when the control mode is set to the second priority output mode,
wherein in a case where the first temperature is equal to or higher than the first temperature reference value and the second temperature is equal to or higher than the second temperature reference value, the power controller sets the control mode to the second priority output mode when the first loss is larger than the second loss, and sets the control mode to the first priority output mode when the second loss is larger than the first loss.

5. The power supply system according to claim 3, further comprising:
a first power circuit including the first electrical storage device;
a second power circuit including the second electrical storage device;
a voltage converter that converts a voltage between the first power circuit and the second power circuit; and
a power converter that connects the first power circuit to the rotary electrical machine,
wherein the power controller sets the control mode to the first priority output mode in a case where the first temperature is equal to or higher than the first temperature reference value and the second temperature is equal to or higher than the second temperature reference value.

6. The power supply system according to claim 3,
wherein the second electrical storage device has a heat capacity smaller than that of the first electrical storage device, and
wherein the power controller sets the control mode to the second priority output mode in a case where the first temperature is lower than the first temperature reference value and the second temperature is lower than the second temperature reference value.

7. The power supply system according to claim 4,
wherein the second electrical storage device has a heat capacity smaller than that of the first electrical storage device, and
wherein the power controller sets the control mode to the second priority output mode in a case where the first temperature is lower than the first temperature reference value and the second temperature is lower than the second temperature reference value.

8. The power supply system according to claim 5,
wherein the second electrical storage device has a heat capacity smaller than that of the first electrical storage device, and
wherein the power controller sets the control mode to the second priority output mode in a case where the first temperature is lower than the first temperature reference value and the second temperature is lower than the second temperature reference value.
